(19) United States
(12) Patent Application Publication
(10) Pub. No.: US 2021/0103955 A1
(43) Pub. Date: Apr. 8, 2021

(54) APPARATUS AND METHOD FOR PROVIDING CONTENTS LINKED WITH INFORMATION OF VEHICLE

(71) Applicant: LG ELECTRONICS INC., Seoul (KR)

(72) Inventors: Hyun Soo KIM, Seoul (KR); Tae Kwon KANG, Seoul (KR); Hyun Sang PARK, Seoul (KR); Sun Yup KIM, Seoul (KR); Dong Heon SHIN, Seoul (KR); Geong Hwan YU, Seoul (KR); Kyung Jun SHIN, Seoul (KR)

(73) Assignee: LG ELECTRONICS INC., Seoul (KR)

(21) Appl. No.: 16/695,099

(22) Filed: Nov. 25, 2019

(30) Foreign Application Priority Data
Oct. 7, 2019 (KR) 10-2019-0123677

(51) Int. Cl. G06Q 30/02; G06Q 30/00; H04W 4/40

(52) U.S. Cl. CPC G06Q 30/0265; H04W 4/40; G06Q 30/018; G06Q 30/0269

(57) ABSTRACT

An embodiment of the present disclosure is a vehicle information-linked content providing apparatus which provides content linked with information provided by a vehicle, the apparatus comprising a storage configured to store a plurality of event data and a plurality of background data, a transceiver configured to receive vehicle information including character matching information, and a controller configured to: select event data including a character designated by the character matching information; select background data including an event designated by the event data; and transmit, through the transceiver, content data including the selected event data and the selected background data. One or more of an autonomous vehicle, a user terminal, and a server according to an embodiment of the present disclosure may be linked or fused/converged with an artificial intelligence module, a drone (unmanned aerial vehicle: UAV), a robot, an augmented reality (AR) device, virtual reality (VR), or a 5G service-related device.

### CROSS-REFERENCE TO RELATED APPLICATION

Pursuant to 35 U.S.C. § 119(a), this application claims the benefit of earlier filing date and right of priority to Korean Patent Application No. 10-2019-0123677, filed on Oct. 7, 2019, the contents of which are hereby incorporated by reference herein in its entirety.

### BACKGROUND

### 1. Technical Field

The present disclosure relates to a content providing apparatus and method, and more particularly, to an apparatus and a method for providing content linked with vehicle information which provide content corresponding to information collected from a vehicle.

### 2. Description of Related Art

Recently, in accordance with the development of technology and the IT industry, research on customized content providing technologies are being implemented to satisfy existing and potential consumers of products.

Specifically, a technology that provides services including customized content for customer satisfaction is being introduced to buyers likely to purchase products, especially buyers of genuine products.

As a related art for providing customized services, as described above, Korean Registered Patent No. 1544965 discloses a technology which collects an authentication code transmitted from an external product and provides information customized for every buyer based on genuine product buyer information when the corresponding product is authenticated as a genuine product by the collected authentication code.

However, according to the related art disclosed in Korean Registered Patent No. 1544965, customized content is only provided based on information on a client buying the product, but customized content cannot be provided based on product information given meaning to the product itself.

For this reason, when customized content is provided, product buyers may feel reluctant to share personal information in a content playback space, and when content is related to a characteristic of the product itself, such as a character product, the character-related content cannot be provided effectively.

Therefore, there is a demand for a technology that appropriately provides content including backgrounds and events connected to owned character products without revealing a personal preference of a customer.

### SUMMARY OF THE INVENTION

The present disclosure provides an apparatus and a method for providing content linked with vehicle information which identifies a related character based on information provided from a vehicle, such as user-possessed product information, user-worn clothing information, or vehicle position information acquired from the vehicle.

The present disclosure further provides an apparatus and a method for providing content linked with a vehicle, which provide content organically reacting to products possessed by a user, when the user possessing a product such as a souvenir that is a genuine products enters the vehicle.

Aspects of the present disclosure are not limited to the above-mentioned aspects, and other technical aspects not mentioned above will be clearly understood by those skilled in the art from the following description.

A vehicle information-linked content providing apparatus according to an embodiment of the present disclosure may be an apparatus which receives information for specifying a character from a vehicle to provide content corresponding to the character.

Specifically, according to an aspect of the present disclosure, a vehicle information-linked content providing apparatus which provides content linked with information provided by a vehicle includes a storage configured to store a plurality of event data and a plurality of background data, a transceiver configured to receive vehicle information including character matching information, and a controller configured to: select event data including a character designated by the character matching information, from among the plurality of event data; select background data including an event designated by the event data, from among the plurality of background data; and transmit, through the transceiver, content data including the selected event data and the selected background data.

In the embodiment of the present disclosure, the vehicle information includes an authentication code, and the controller determines that a product assigned with the authentication code is a genuine product based on comparing the authentication code with genuine product determining information, and transmits the content data through the transceiver based on the determination that the product is a genuine product.

In the embodiment of the present disclosure, the event data includes image data added so as to correspond to a pointer aiming coordinate of the product.

In the embodiment of the present disclosure, the character matching information includes vehicle position information, and the controller designates a character in accordance with a characteristic of a location adjacent to a vehicle location based on the vehicle position information.

In the embodiment of the present disclosure, the character matching information includes inside-vehicle image information, and the controller designates a character based on the inside-vehicle image information.

In the embodiment of the present disclosure, the character matching information includes inside-vehicle voice information, and the controller designates a character based on the inside-vehicle voice information.

In the embodiment of the present disclosure, the storage stores a history of providing the content data, and the controller selects at least one new event data which has not been provided, from among the plurality of event data, based on the providing history stored in the storage; and selects event data including a character designated by the character matching information, from among at least one new event data.

In the embodiment of the present disclosure, the transceiver receives the vehicle information based on an uplink grant of a 5G network connected to drive the vehicle in an autonomous driving mode.

According to another aspect of the present disclosure, a vehicle information-linked content providing method which provides content linked with information provided by a vehicle includes: storing a plurality of event data and a plurality of background data; receiving vehicle information including character matching information; selecting event data including a character designated by the character matching information, from among the plurality of event data; selecting background data including an event designated by the event data, from among the plurality of background data; and transmitting content data including the selected event data and the selected background data.

In the embodiment of the present disclosure, the vehicle information includes an authentication code, and the transmitting of content data includes: determining that a product assigned with the authentication code is a genuine product by comparing the authentication code with genuine product determining information; and transmitting content data including event data and background data based on the determination that the product is a genuine product.

In the embodiment of the present disclosure, the event data includes image data added so as to correspond to a pointer aiming coordinate of the product.

In the embodiment of the present disclosure, the character matching information includes vehicle position information, and the selecting of event data includes designating a character in accordance with a characteristic of a location adjacent to a vehicle location based on the vehicle position information.

In the embodiment of the present disclosure, the character matching information includes inside-vehicle image information, and the selecting of event data includes designating a character based on the inside-vehicle image information.

In the embodiment of the present disclosure, the character matching information includes inside-vehicle voice information, and the selecting of event data includes designating a character based on the inside-vehicle voice information.

In the embodiment of the present disclosure, the method further includes storing a history of providing the content data, and the selecting of event data includes: selecting at least one new event data which has not been provided, from among the plurality of event data, based on the providing history; and selecting event data including a character designated by the character matching information, from among at least one new event data.

In the embodiment of the present disclosure, the receiving of vehicle information includes receiving the vehicle information based on an uplink grant of a 5G network connected to drive the vehicle in an autonomous driving mode.

According to another aspect of the present disclosure, a computer readable recording medium, in which a vehicle information-linked content providing program which provides content linked with information provided by a vehicle is recorded, the vehicle information-linked content providing program causing a computer to perform: storing of a plurality of event data and a plurality of background data; receiving of vehicle information including character matching information; selecting of event data including a character designated by the character matching information, from among the plurality of event data; selecting of background data including an event designated by the event data, from among the plurality of background data; and transmitting of content data including the selected event data and the selected background data.

Details of other embodiments are included in the detailed description and drawings.

According to the embodiment of the present disclosure, a corresponding character is determined based on information collected from a user who enters the vehicle or vehicle position information, and appropriate content is provided by utilizing a travel time of a vehicle passenger, in accordance with the determined character, to provide a character experience preferred by the passenger and increase the desire to purchase a product.

According to the embodiment of the present disclosure, various content which directly react with a genuine character souvenir are provided to a character souvenir buyer, to induce the vehicle passenger to buy the genuine product.

Embodiments of the present disclosure are not limited to the embodiments described above, and other embodiments not mentioned above will be clearly understood from the description below.

### BRIEF DESCRIPTION OF DRAWINGS

The above and other aspects, features, and advantages of the present disclosure will become apparent from the detailed description of the following aspects in conjunction with the accompanying drawings, in which:

FIG. 1 is a diagram illustrating a system to which a vehicle information-linked content providing apparatus according to an embodiment of the present disclosure is applied;

FIG. 2 is a block diagram illustrating a vehicle information-linked content providing apparatus according to an embodiment of the present disclosure which is installed in a server;

FIG. 3 is a block diagram illustrating a vehicle information-linked content providing apparatus according to an embodiment of the present disclosure which is installed in a vehicle;

FIG. 4 is a block diagram illustrating a vehicle information-linked content providing apparatus according to an embodiment of the present disclosure which is installed in a product;

FIG. 5 is a diagram illustrating an example of the basic operation of an autonomous vehicle and a 5G network in a 5G communication system.

FIG. 6 is a view illustrating an example of an applied operation of an autonomous vehicle and a 5G network in a 5G communication system;

FIGS. 7 to 10 are views illustrating an example of an operation of an autonomous vehicle using 5G communication; and

FIGS. 11 to 15 are operation flowcharts illustrating a vehicle information-linked content providing method according to an embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. Further, in the description of the embodiments of the present disclosure, when it is determined that the detailed description of the related art would obscure the gist of the present disclosure, the description thereof will be omitted. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

Although the terms first, second, third, and the like, may be used herein to describe various elements, components, regions, layers, and/or sections, these elements, components, regions, layers, and/or sections should not be limited by these terms. These terms are only used to distinguish one element from another.

Similarly, it will be understood that when an element is referred to as being “connected,” “attached,” or “coupled” to another element, it can be directly connected, attached, or coupled to the other element, or intervening elements may be present. In contrast, when an element is referred to as being “directly on,” “directly engaged to,” “directly connected to,” or “directly coupled to” another element or layer, there may be no intervening elements or layers present.

As used herein, the singular forms “a,” “an,” and “the” are intended to include the plural forms as well, unless the context clearly indicates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

A vehicle described in this specification refers to a car, an automobile, and the like. In the following, the vehicle will be described mainly as an automobile.

The vehicle described in the present disclosure may include, but is not limited to, a vehicle having an internal combustion engine as a power source, a hybrid vehicle having an engine and an electric motor as a power source, and an electric vehicle having an electric motor as a power source.

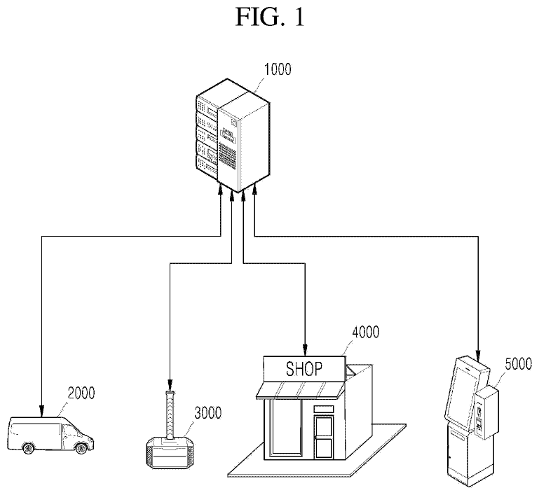

FIG. 1 is a diagram illustrating a system to which a vehicle information-linked content providing apparatus according to an embodiment of the present disclosure is applied.

Referring to FIG. 1, a server 1000 is a control system which may control an autonomous driving mode of a vehicle 2000 and provide content to be provided to the vehicle 2000, for example, content data including images and sounds related to a movie or an animation featuring famous characters such as Spider-Man, Iron Man, and Thor.

The server 1000 may include a user information server which manages buyer information of a product 3000, a reservation server which manages reservation information of the vehicle 2000, and a media server which manages content data, but is not limited thereto.

The user may use a reservation device 5000 to make a reservation to allocate vehicles 2000 and select content to be played.

The reservation device 5000 may be a personal computer (PC), a mobile device, or a kiosk and may include a communication module to communicate with the server 1000.

The server 1000 may sense that the vehicle 2000 approaches a specific location 4000 in accordance with position information provided from the vehicle 2000. In this case, the specific location 4000 may be a souvenir shop or an attraction.

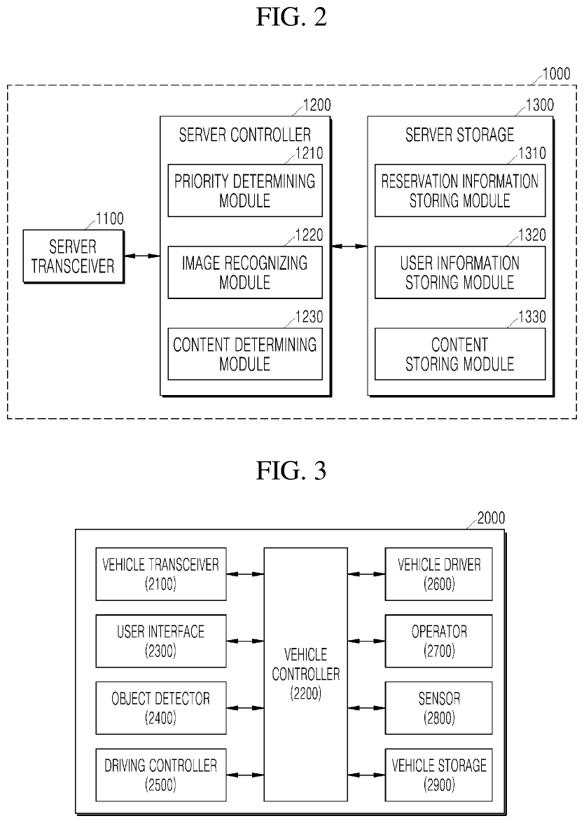

FIG. 2 is a block diagram illustrating a vehicle information-linked content providing apparatus according to an embodiment of the present disclosure which is installed in a server.

Referring to FIG. 2, the vehicle information-linked content providing apparatus may include a server transceiver 1100, a server controller 1200, and a server storage 1300.

According to an embodiment, the server 1000 to which the vehicle information-linked content providing apparatus is applied may include components other than the components to be described which are illustrated in FIG. 2 or may not include some of the components to be described which are illustrated in FIG. 2. In FIG. 2, it is assumed that the vehicle information-linked content providing apparatus is mounted in the server 1000, but the same apparatus may be applied to the vehicle 2000.

The server transceiver 1100 may receive vehicle information including character matching information and provide the received vehicle information to the server controller 1200. Specifically, the server transceiver 1100 may receive vehicle information based on an uplink grant of a 5G network connected to drive the vehicle 2000 in an autonomous driving mode.

The vehicle information is information provided by the vehicle 2000 and may include character matching information which can specify a character which is featured in a movie.

The server transceiver 1100 may receive content data from the server controller 1200 and transmit the content data to the vehicle 2000 under the control of the server controller 1200.

The server controller 1200 may include a priority determining module 1210, an image recognizing module 1220, and a content determining module 1230.

The content determining module 1230 of the server controller 1200 may select event data including a character designated by the character matching information, from among a plurality of event data, select background data including an event designated by event data, from among a plurality of background data, and transmit content data including the selected event data and the selected background data through the server transceiver 1100.

The character matching information may be any one of an authentication code of a product 3000, an image of a character costume or the product 3000 included in inside-vehicle image information, a sound designating a character included in inside-vehicle voice information, or position information of the vehicle 2000. For example, when a Spider-Man costume is captured in the inside-vehicle image information, a character designated by the inside-vehicle image information may be Spider-Man.

The background data is an image including a background in the movie or the animation and sound data. For example, images including Venice, New York, and Prague in the movie Spider-Man: Far From Home and the song “I Will Always Love You” by Whitney Houston may correspond to the background data.

The event data is data for reproducing an event occurring in the above-described background data and in one event data, at least one character including a character designated by the character matching information may appear. For example, the Ferris wheel scene in the movie Spider-Man: Far From Home may be configured as one event data and in the event data, characters including Spider-Man, and/or other than Spider-Man such as Fire Elemental or Mysterio designated by the character matching information may appear.

The event data may include image data which is added so as to correspond to a pointer aiming coordinate of the product 3000. For example, when the user aims a predetermined point of an image which is being played by a pointer mounted in Thor's hammer, Mjolnir, the event data may include data for displaying an image showing that a character in the image disposed in the coordinate aimed by the pointer is hit by a thunderbolt.

The server controller 1200 may determine that the product 3000 assigned with the authentication code is a genuine product based on comparing the authentication code of the product 3000 with genuine product determination information, and based on the determination that the product 3000 is a genuine product, may transmit the content data through the server transceiver 1100.

When a procedure for determining whether the product 3000 is a genuine product is performed in the vehicle 2000, the server controller 1200 may receive a product list through the server transceiver 1100 and transmit content data selected based on the received product list through the server transceiver 1100.

When a plurality of character matching information is included in the vehicle information received through the server transceiver 1100, the priority determining module 1210 included in the server controller 1200 may determine character matching information having top priority to be applied to designate the character. For example, when vehicle information including a plurality of authentication codes of the product 3000 is received through the server transceiver 1100, the priority determining module 1210 may determine an authentication code of the latest released product as character matching information having the top priority.

The server controller 1200 may designate the character in accordance with the characteristic of the specific location 4000 adjacent to the position of the vehicle based on the position information of the vehicle 2000. For example, when the specific location 4000 is a souvenir shop selling Spider-Man goods, the server controller 1200 may designate Spider-Man as a character, and when the specific location 4000 is a Star Tours attraction, the server controller 1200 may designate Luke Skywalker as a character.

The server controller 1200 may designate the character based on the inside-vehicle image information of the vehicle 2000. For example, when a shape of Mjolnir is recognized from the inside-vehicle image of the vehicle 2000, the server controller 1200 may designate Thor as a character, and when a shape of a passenger wearing a Spider-Man costume is recognized from the inside-vehicle image of the vehicle 2000, the server controller 1200 may designate Spider-Man as a character. In this case, when vehicle information including an image obtained by capturing Mjolnir carried by an adult and a Spider-Man costume worn by a child in the vehicle 2000 is received through the server transceiver 1100, the priority determining module 1210 may determine the image of the Spider-Man costume worn by the child as character matching information having the top priority.

The image recognizing module 1220 included in the server controller 1200 may determine, for designating a character in the image, a type of the product 3000, a characteristic (men and women of all ages) of a user carrying the product 3000 or wearing a costume, and the character costume by inputting the inside-vehicle image of the vehicle 2000 received through the server transceiver 1100 to a prediction model which has been machine-trained in advance.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of the artificial intelligence into various fields of information technology to solve problems in the respective fields.

Machine learning is an area of artificial intelligence that includes the field of study that gives computers the capability to learn without being explicitly programmed.

Specifically, machine learning may be a technology for researching and constructing a system for learning, predicting, and improving its own performance based on empirical data and an algorithm for the same. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) from among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

A deep neural network with a plurality of hidden layers between the input layer and the output layer may be the most representative type of artificial neural network which enables deep learning, which is one machine learning technique.

An ANN can be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

From among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which from among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

The server controller 1200 may designate the character based on the inside-vehicle voice information of the vehicle 2000. For example, when the word “Heimdall” is recognized from the voice in the vehicle 2000, the server controller 1200 may designate Heimdall, who is Gatekeeper of Asgard, as a character.

The server controller 1200 may select at least one new event data which has not been provided to a user, from among the plurality of event data, based on content data providing history, that is, a history of providing content data to a user who is registered to buy the product 3000 specified by the authentication code and select event data including a character designated by the character matching information, from among at least one new event data.

The server storage 1300 may include a reservation information storing module 1310, a user information storing module 1320, and a content storing module 1330.

The content storing module 1330 included in the server storage 1300 may store a plurality of event data and a plurality of background data. The plurality of event data and the plurality of background data stored in the server storage 1300 may have a structure to be designated in accordance with the character to be described below.

TABLE 1

| Background | Event | Character |
|---|---|---|
| Background 1 | Default Event 1 | Default character |
| | Event 1 | Character 1, Character 2, Character 6 |
| | Event 2 | Character 5, Character 7, Character 8 |
| | Event 3 | All characters |
| | . . . | . . . |
| . . . | . . . | . . . |

For example, when Character 1 is Thor Odinson from Thor, an authentication code of Mjolnir produced in the first half of 2011 and an image including the shape of a costume worn by Thor Odinson in the poster of Thor may be character matching information which designates Character 1. When the authentication code of Mjolnir produced in the first half of 2011 is received as the character matching information through the server transceiver 1100, the server controller 1200 may select Event 1 and Event 3, from data stored in the server storage 1300, as event data and select Background 1 which is background data connected to Event 1 and Event 3. In which case, when the same shape of the product 3000 is provided, for example, even though the product 3000 is Mjolnir, different characters may be designated depending on a manufacturing date. Specifically, Character 1 who is Thor with long hair may be designated for Mjolnir produced in the first half of 2011, and Character 5 who is Thor with a sport-cut style may be designated for Mjolnir produced in the second half of 2017.

The user information storing module 1320 included in the server storage 1300 may store user information such as attraction usage information, product purchase information, and content data providing history of a user who buys the product 3000.

When two event data (Event 1 and Event 3) are selected as described above, the server controller 1200 may search for the content data providing history stored in the server storage 1300, and when there is a history of providing Event 1 to the user who buys the Mjolnir, may select Event 3 which the user has not experienced as event data to be provided at this time. That is, the server controller 1200 may transmit content data including Event 3 as event data and Background 1 as background data to the vehicle 2000 through the server transceiver 1100.

The reservation information storing module 1310 included in the server storage 1300 may store content determining information and vehicle (2000) reservation information input through the reservation device 5000.

The server storage 1300 may be various storage devices such as a ROM, a RAM, an EPROM, a flash drive, and a hard drive, in terms of hardware. The server storage 1300 may store various data for overall operation of the server 1000, such as a program for processing or controlling the server controller 1200, in particular user propensity information. The server storage 1300 may be integrally formed with the server controller 1200, or implemented as a sub-component of the server controller 1200.

FIG. 3 is a block diagram illustrating a vehicle information-linked content providing apparatus according to an embodiment of the present disclosure which is installed in a vehicle.

Referring to FIG. 3, the vehicle information-linked content providing apparatus may include a vehicle transceiver 2100, a vehicle controller 2200, a user interface 2300, an object detector 2400, a driving controller 2500, a vehicle driver 2600, an operator 2700, a sensor 2800, and a vehicle storage 2900.

According to an embodiment, the vehicle 2000 to which the vehicle information-linked content providing apparatus is applied may include components other than components to be described which are illustrated in FIG. 3 or may not include some of the components to be described which are illustrated in FIG. 3.

The vehicle 2000 may be switched from an autonomous driving mode to a manual mode, or switched from the manual mode to the autonomous driving mode depending on the driving situation. Here, the driving situation may be determined by at least one of the information received by the vehicle transceiver 2100, the external object information detected by the object detector 2400, or the navigation information acquired by the navigation module.

The vehicle 2000 may be switched from the autonomous driving mode to the manual mode, or from the manual mode to the autonomous driving mode, according to a user input received through the user interface 2300.

When the vehicle 2000 is operated in the autonomous driving mode, the vehicle 2000 may be operated under the control of the operator 2700 that controls driving, parking, and unparking. When the vehicle 2000 is operated in the manual mode, the vehicle 2000 may be operated by an input of the driver's mechanical driving operation.

The vehicle transceiver 2100 may be a module for performing communication with an external device. Here, the external device may be the server 1000, the product 3000, a communication module which is installed in the specific location 4000, and the reservation device 5000.

The vehicle transceiver 2100 receives a mode designating signal from the server 1000 and provides the received mode designating signal to the vehicle controller 2200.

The vehicle transceiver 2100 may receive vehicle information from the vehicle controller 2200 and transmit the received vehicle information to the server 1000.

The vehicle transceiver 2100 may include at least one from among a transmission antenna, a reception antenna, a radio frequency (RF) circuit capable of implementing various communication protocols, or an RF element in order to perform communication.

The vehicle transceiver 2100 may perform short range communication, GPS signal reception, V2X communication, optical communication, broadcast transmission/reception, and intelligent transport systems (ITS) communication functions.

The vehicle transceiver 2100 may further support other functions than the functions described, or may not support some of the functions described, depending on the embodiment.

The vehicle transceiver 2100 may support short-range communication by using at least one from among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

The vehicle transceiver 2100 may receive the authentication code of the product 3000 by using a Bluetooth or an NFC technique and provide the received authentication code to the vehicle controller 2200.

The vehicle transceiver 2100 may form short-range wireless communication networks so as to perform short-range communication between the vehicle 2000 and at least one external device.

The vehicle transceiver 2100 may include a Global Positioning System (GPS) module or a Differential Global Positioning System (DGPS) module for obtaining location information of the vehicle 2000.

The vehicle transceiver 2100 may include a module for supporting wireless communication between the vehicle 2000 and a server (V2I: vehicle to infrastructure), communication with another vehicle (V2V: vehicle to vehicle) or communication with a pedestrian (V2P: vehicle to pedestrian). That is, the vehicle transceiver may include a V2X communication module. The V2X communication module may include an RF circuit capable of implementing V2I, V2V, and V2P communication protocols.

The vehicle transceiver 2100 may receive a danger information broadcast signal transmitted by another vehicle through the V2X communication module, and may transmit a danger information inquiry signal and receive a danger information response signal in response thereto.

The vehicle transceiver 2100 may include an optical communication module for performing communication with an external device via light. The optical communication module may include a light transmitting module for converting an electrical signal into an optical signal and transmitting the optical signal to the outside, and a light receiving module for converting the received optical signal into an electrical signal.

The light transmitting module may be formed to be integrated with the lamp included in the vehicle 2000.

The vehicle transceiver 2100 may include a broadcast communication module for receiving broadcast signals from an external broadcast management server, or transmitting broadcast signals to the broadcast management server through broadcast channels. The broadcast channel may include a satellite channel and a terrestrial channel Examples of the broadcast signal may include a TV broadcast signal, a radio broadcast signal, and a data broadcast signal.

The vehicle transceiver 2100 may include an ITS communication module that exchanges information, data or signals with a traffic system. The ITS communication module may provide the obtained information and data to the traffic system. The ITS communication module may receive information, data, or signals from the traffic system. For example, the ITS communication module may receive road traffic information from the communication system and provide the road traffic information to the vehicle controller 2200. For example, the ITS communication module may receive control signals from the traffic system and provide the control signals to the vehicle controller 2200 or a processor provided in the vehicle 2000.

Depending on the embodiment, the overall operation of each module of the vehicle transceiver 2100 may be controlled by a separate process provided in the vehicle transceiver 2100. The vehicle transceiver 2100 may include a plurality of processors, or may not include a processor. When a processor is not included in the vehicle transceiver 2100, the vehicle transceiver 2100 may be operated by either a processor of another apparatus in the vehicle 2000 or the vehicle controller 2200.

The vehicle transceiver 2100 may, together with the user interface 2300, implement a vehicle-use display device. In this case, the vehicle display device may be referred to as a telematics device or an audio video navigation (AVN) device.

FIG. 5 is a diagram illustrating an example of the basic operation of an autonomous vehicle and a 5G network in a 5G communication system.

The vehicle transceiver 2100 may transmit specific information over a 5G network when the vehicle 2000 is operated in the autonomous driving mode.

The specific information may include autonomous driving related information.

The autonomous driving related information may be information directly related to the driving control of the vehicle. For example, the autonomous driving related information may include at least one from among object data indicating an object near the vehicle, map data, vehicle status data, vehicle location data, and driving plan data.

The autonomous driving related information may further include service information necessary for autonomous driving. For example, the specific information may include information on a destination inputted through the user interface 2300 and a safety rating of the vehicle.

In addition, the 5G network may determine whether the vehicle is to be remotely controlled (S2).

The 5G network may include a server or a module for performing remote control related to autonomous driving.

The 5G network may transmit information (or a signal) related to the remote control to an autonomous vehicle (S3).

As described above, information related to the remote control may be a signal directly applied to the autonomous vehicle, and may further include service information necessary for autonomous driving. The autonomous vehicle according to this embodiment may receive service information such as insurance for each interval selected on a driving route and risk interval information, through a server connected to the 5G network to provide services related to the autonomous driving.

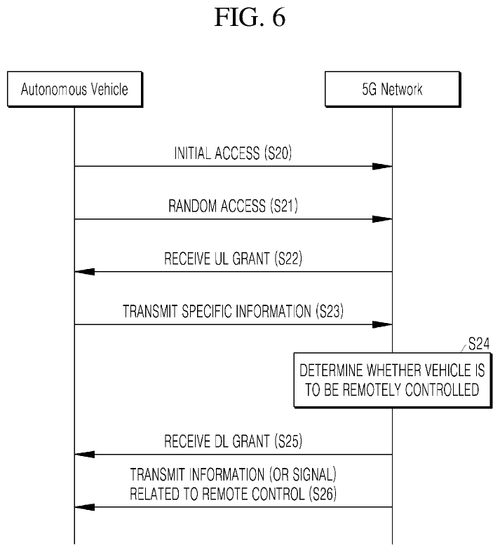

An essential process for performing 5G communication between the autonomous vehicle 2000 and the 5G network (for example, an initial access process between the vehicle 2000 and the 5G network) will be briefly described with reference to FIG. 6 to FIG. 10 below.

An example of application operations through the autonomous vehicle 2000 performed in the 5G communication system and the 5G network is as follows.

The vehicle 2000 may perform an initial access process with the 5G network (initial access step, S20). In this case, the initial access procedure includes a cell search process for acquiring downlink (DL) synchronization and a process for acquiring system information.

The vehicle 2000 may perform a random access process with the 5G network (random access step, S21). At this time, the random access procedure includes an uplink (UL) synchronization acquisition process or a preamble transmission process for UL data transmission, a random access response reception process, and the like.

The 5G network may transmit an Uplink (UL) grant for scheduling transmission of specific information to the autonomous vehicle 2000 (UL grant receiving step, S22).

The procedure by which the vehicle 2000 receives the UL grant includes a scheduling process in which a time/frequency resource is allocated for transmission of UL data to the 5G network.

The autonomous vehicle 2000 may transmit specific information over the 5G network based on the UL grant (specific information transmission step, S23).

The 5G network may determine whether the vehicle 2000 is to be remotely controlled based on the specific information transmitted from the vehicle 2000 (vehicle remote control determination step, S24).

The autonomous vehicle 2000 may receive the DL grant through a physical DL control channel for receiving a response on pre-transmitted specific information from the 5G network (DL grant receiving step, S25).

The 5G network may transmit information (or a signal) related to the remote control to the autonomous vehicle 2000 based on the DL grant (remote control related information transmission step, S26).

A process in which the initial access process and/or the random access process between the 5G network and the autonomous vehicle 2000 is combined with the DL grant receiving process has been exemplified. However, the present disclosure is not limited thereto.

For example, an initial access procedure and/or a random access procedure may be performed through an initial access step, an UL grant reception step, a specific information transmission step, a remote control decision step of the vehicle, and an information transmission step associated with remote control. In addition, for example, the initial access process and/or the random access process may be performed through the random access step, the UL grant receiving step, the specific information transmission step, the vehicle remote control determination step, and the remote control related information transmission step. The autonomous vehicle 2000 may be controlled by the combination of an AI operation and the DL grant receiving process through the specific information transmission step, the vehicle remote control determination step, the DL grant receiving step, and the remote control related information transmission step.

The operation of the autonomous vehicle 2000 described above is merely exemplary, but the present disclosure is not limited thereto.

For example, the operation of the autonomous vehicle 2000 may be performed by selectively combining the initial access step, the random access step, the UL grant receiving step, or the DL grant receiving step with the specific information transmission step, or the remote control related information transmission step. The operation of the autonomous vehicle 2000 may include the random access step, the UL grant receiving step, the specific information transmission step, and the remote control related information transmission step. The operation of the autonomous vehicle 2000 may include the initial access step, the random access step, the specific information transmission step, and the remote control related information transmission step. The operation of the autonomous vehicle 2000 may include the UL grant receiving step, the specific information transmission step, the DL grant receiving step, and the remote control related information transmission step.

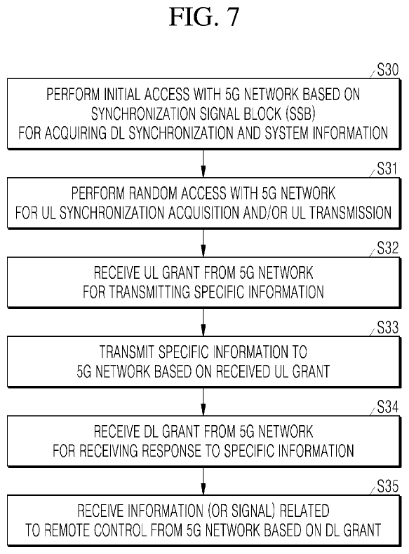

As illustrated in FIG. 7, the vehicle 2000 including an autonomous driving module may perform an initial access process with the 5G network based on Synchronization Signal Block (SSB) for acquiring DL synchronization and system information (initial access step, S30).

The autonomous vehicle 2000 may perform a random access process with the 5G network for UL synchronization acquisition and/or UL transmission (random access step, S31).

The autonomous vehicle 2000 may receive the UL grant from the 5G network for transmitting specific information (UL grant receiving step, S32).

The autonomous vehicle 2000 may transmit the specific information to the 5G network based on the UL grant (specific information transmission step, S33).

The autonomous vehicle 2000 may receive the DL grant from the 5G network for receiving a response to the specific information (DL grant receiving step, S34).

The autonomous vehicle 2000 may receive remote control related information (or a signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

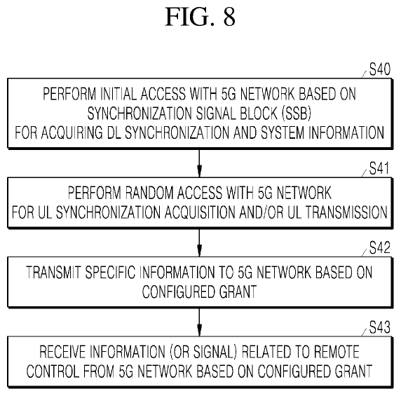

As illustrated in FIG. 8, the autonomous vehicle 2000 may perform an initial access process with the 5G network based on SSB for acquiring DL synchronization and system information (initial access step, S40).

The autonomous vehicle 2000 may perform a random access process with the 5G network for UL synchronization acquisition and/or UL transmission (random access step, S41).

The autonomous vehicle 2000 may transmit specific information based on a configured grant to the 5G network (UL grant receiving step, S42). In other words, the autonomous vehicle 1000 may receive the configured grant instead of receiving the UL grant from the 5G network.

The autonomous vehicle 2000 may receive information (or a signal) related to remote control from the 5G network based on the setting grant (remote control related information receiving step, S43).

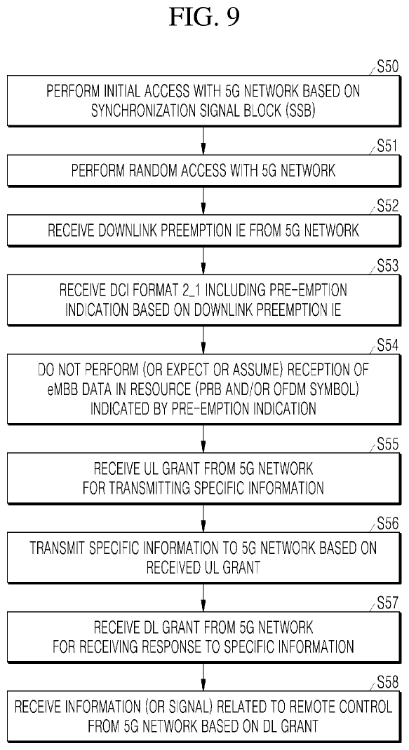

As illustrated in FIG. 9, the autonomous vehicle 2000 may perform an initial access process with the 5G network based on SSB for acquiring DL synchronization and system information (initial access step, S50).

The autonomous vehicle 2000 may perform a random access process with the 5G network for UL synchronization acquisition and/or UL transmission (random access step, S51).

In addition, the autonomous vehicle 2000 may receive Downlink Preemption (DL) and Information Element (IE) from the 5G network (DL Preemption IE reception step, S52).

The autonomous vehicle 2000 may receive DCI (Downlink Control Information) format 2_1 including preemption indication based on the DL preemption IE from the 5G network (DCI format 2_1 receiving step, S53).

The autonomous vehicle 2000 may not perform (or expect or assume) the reception of eMBB data in the resource (PRB and/or OFDM symbol) indicated by the pre-emption indication (step of not receiving eMBB data, S54).

The autonomous vehicle 2000 may receive the UL grant over the 5G network for transmitting specific information (UL grant receiving step, S55).

The autonomous vehicle 2000 may transmit the specific information to the 5G network based on the UL grant (specific information transmission step, S56).

The autonomous vehicle 2000 may receive the DL grant from the 5G network for receiving a response to the specific information (DL grant receiving step, S57).

The autonomous vehicle 2000 may receive the remote control related information (or signal) from the 5G network based on the DL grant (remote control related information receiving step, S58).

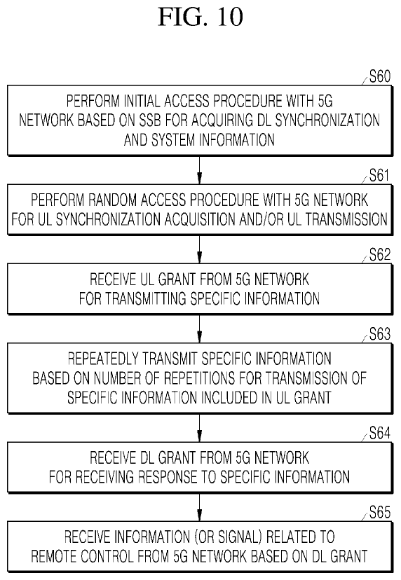

As illustrated in FIG. 10, the autonomous vehicle 2000 may perform an initial access process with the 5G network based on SSB for acquiring DL synchronization and system information (initial access step, S60).

The autonomous vehicle 2000 may perform a random access process with the 5G network for UL synchronization acquisition and/or UL transmission (random access step, S61).

The autonomous vehicle 2000 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous vehicle 2000 may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of Resource Block (6RB) and Resource Block (1RB).

The autonomous vehicle 2000 may receive the DL grant from the 5G network for receiving a response to the specific information (DL grant receiving step, S64).

The autonomous vehicle 2000 may receive the remote control related information (or signal) from the 5G network based on the DL grant (remote control related information receiving step, S65).

The above-described 5G communication technique can be applied in combination with the embodiment proposed in this specification, which will be described in FIG. 1 to FIG. 13F, or supplemented to specify or clarify the technical feature of the embodiment proposed in this specification.

The vehicle 2000 may be connected to an external server through a communication network, and may be capable of moving along a predetermined route without a driver's intervention by using an autonomous driving technique.

In the following embodiments, the user may be interpreted as a driver, a passenger, or the owner of a user terminal.

While the vehicle 2000 is driving in the autonomous driving mode, the type and frequency of accident occurrence may depend on the capability of the vehicle 1000 of sensing dangerous elements in the vicinity in real time. The route to the destination may include sectors having different levels of risk due to various causes such as weather, terrain characteristics, traffic congestion, and the like.

At least one from among an autonomous vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

For example, the vehicle 2000 may operate in association with at least one artificial intelligence module or robot included in the vehicle 2000 in the autonomous driving mode.

For example, the vehicle 2000 may interact with at least one robot. The robot may be an autonomous mobile robot (AMR) capable of driving by itself. Being capable of driving by itself, the AMR may freely move, and may include a plurality of sensors so as to avoid obstacles during traveling. The AMR may be a flying robot (such as a drone) equipped with a flight device. The AMR may be a wheel-type robot equipped with at least one wheel, and which is moved through the rotation of the at least one wheel. The AMR may be a leg-type robot equipped with at least one leg, and which is moved using the at least one leg.

The robot may function as a device that enhances the convenience of a user of a vehicle. For example, the robot may move a load placed in the vehicle 2000 to a final destination. For example, the robot may perform a function of providing route guidance to a final destination to a user who alights from the vehicle 2000. For example, the robot may perform a function of transporting the user who alights from the vehicle 2000 to the final destination

At least one electronic apparatus included in the vehicle 2000 may communicate with the robot through a communication device.

At least one electronic apparatus included in the vehicle 2000 may provide, to the robot, data processed by the at least one electronic apparatus included in the vehicle 1000. For example, at least one electronic apparatus included in the vehicle 2000 may provide, to the robot, at least one from among object data indicating an object near the vehicle, HD map data, vehicle status data, vehicle position data, and driving plan data.

At least one electronic apparatus included in the vehicle 2000 may receive, from the robot, data processed by the robot. At least one electronic apparatus included in the vehicle 2000 may receive at least one from among sensing data sensed by the robot, object data, robot status data, robot location data, and robot movement plan data.

At least one electronic apparatus included in the vehicle 2000 may generate a control signal based on data received from the robot. For example, at least one electronic apparatus included in the vehicle may compare information on the object generated by an object detection device with information on the object generated by the robot, and generate a control signal based on the comparison result. At least one electronic device included in the vehicle 2000 may generate a control signal so as to prevent interference between the route of the vehicle and the route of the robot.

At least one electronic apparatus included in the vehicle 2000 may include a software module or a hardware module for implementing an artificial intelligence (AI) (hereinafter referred to as an artificial intelligence module). At least one electronic device included in the vehicle may input the acquired data to the AI module, and use the data which is outputted from the AI module.

The artificial intelligence module may perform machine learning of input data by using at least one artificial neural network (ANN). The artificial intelligence module may output driving plan data through machine learning of input data.

At least one electronic apparatus included in the vehicle 2000 may generate a control signal based on the data outputted from the artificial intelligence module.

According to the embodiment, at least one electronic apparatus included in the vehicle 2000 may receive data processed by an artificial intelligence from an external device through a communication device. At least one electronic apparatus included in the vehicle may generate a control signal based on the data processed by the artificial intelligence.

The vehicle controller 2200 may receive a control signal of the server 1000 through the vehicle transceiver 2100 and control the autonomous driving mode operation in accordance with the control signal.

The vehicle controller 2200 may download the content data through the vehicle transceiver 2100 and play the downloaded content data through the user interface 2300. The vehicle controller 2200 may execute a dedicated application to play the content data.

The vehicle controller 2200 may generate the character matching information by using the authentication code of the product 3000 input through the vehicle transceiver 2100, a GPS signal, and an internal camera image and an internal microphone voice input through the user interface 2300. The vehicle controller 2200 may transmit the generated character matching information to the server 1000 through the vehicle transceiver 2100.

The vehicle controller 2200 may be implemented using at least one from among application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and other electronic units for performing other functions.

The user interface 2300 may allow interaction between the vehicle 2000 and a vehicle user, receive an input signal of the user, transmit the received input signal to the vehicle controller 2200, and provide information included in the vehicle 2000 to the user under the control of the vehicle controller 2200. The user interface 2300 may include an input module, an internal microphone, an internal camera, an infrared laser sensing module, and an output module, but is not limited thereto.

The input module is for receiving information from a user. The data collected by the input module may be analyzed by the vehicle controller 2200 and processed by the user's control command.

The input module may receive the destination of the vehicle 2000 from the user and provide the destination to the controller 2200.

The input module may input to the vehicle controller 2200 a signal for designating and deactivating at least one of the plurality of sensor modules of the object detector 2400 according to the user's input.

The input module may be disposed inside the vehicle. For example, the input module may be disposed on one area of a steering wheel, one area of an instrument panel, one area of a seat, one area of each pillar, one area of a door, one area of a center console, one area of a head lining, one area of a sun visor, one area of a windshield, or one area of a window.

The internal microphone may provide a voice including a character-related conversation to the vehicle controller 2200.

The internal camera may provide, to the vehicle controller 2200, an image in the vehicle 2000 which includes the shape of the product 3000 or the shape of the character costume.

The output module is for generating an output related to visual, auditory, or tactile information. The output module may output a sound or an image.

The output module may include at least one of a display module, an acoustic output module, and a haptic output module.

The display module may display graphic objects corresponding to various information.

The display module may display content data including background data and event data as a user recognizable image in accordance with the control of the vehicle controller 2200.

The display module may include at least one of a liquid crystal display (LCD), a thin film transistor liquid crystal display (TFT LCD), an organic light emitting diode (OLED), a flexible display, a 3D display, or an e-ink display, and may be installed externally of the vehicle, specifically, on the outside of a door of an accommodating space.

The display module may have a mutual layer structure with a touch input module, or may be integrally formed to implement a touch screen.

The display module may be implemented as a head up display (HUD). When the display module is implemented as an HUD, the display module may include a projection module to output information through an image projected onto a windshield or a window.

The display module may include a transparent display. The transparent display may be attached to the windshield or the window.

The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted.

The user interface 2300 may include a plurality of display modules.

The display module may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The infrared laser sensing module may sense an aiming coordinate of an infrared laser pointer, which is an example of a pointer 3200 of the product 3000, and provide a sensed aiming coordinate value to the vehicle controller 2200.

The vehicle controller 2200 may output image data which is added so as to correspond to the pointer aiming coordinate of the product 3000, from among event data downloaded from the server, based on the aiming coordinate value provided from the infrared laser sensing module, through the display module.

The sound output module may convert an electrical signal provided from the vehicle controller 2200 into an audio signal. The sound output module may include at least one speaker. The sound output module may output content data, including background data and event data, as a user recognizable sound in accordance with the control of the vehicle controller 2200.

The haptic output module may generate a tactile output. For example, the haptic output module may operate to allow the user to perceive the output by vibrating a steering wheel, a seat belt, and a seat.

The object detector 2400 is for detecting an object located outside the vehicle 2000. The object detector 2400 may generate object information based on the sensing data, and transmit the generated object information to the vehicle controller 2200. Examples of the object may include various objects related to the driving of the vehicle 2000, such as a lane, another vehicle, a pedestrian, a motorcycle, a traffic signal, light, a road, a structure, a speed bump, a landmark, and an animal.

The object detector 2400 is a plurality of sensor modules and may include a camera module, a lidar (light imaging detection and ranging), an ultrasonic sensor, a radar (radio detection and ranging) 1450, and an infrared sensor.

The object detector 2400 may sense environmental information around the vehicle 2000 through a plurality of sensor modules.

Depending on the embodiment, the object detector 2400 may further include components other than the components described, or may not include some of the components described.

The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method.

The radar may detect an object based on a time-of-flight (TOF) method or a phase-shift method using an electromagnetic wave as a medium, and detect the location of the detected object, the distance to the detected object, and the relative speed of the detected object.

The radar may be disposed at an appropriate location outside the vehicle for sensing an object disposed at the front, back, or side of the vehicle.

The lidar may include a laser transmitting module, and a laser receiving module. The lidar may be embodied using the time of flight (TOF) method or in the phase-shift method.

The lidar may be implemented as a driven type or a non-driven type.

When the lidar is embodied in the driving method, the lidar may rotate by means of a motor, and detect an object near the vehicle 2000. When the lidar is implemented in the non-driving method, the lidar may detect an object within a predetermined range with respect to the vehicle 2000 by means of light steering. The vehicle 2000 may include a plurality of non-driven type lidars.

The lidar may detect an object using the time of flight (TOF) method or the phase-shift method using laser light as a medium, and detect the location of the detected object, the distance from the detected object and the relative speed of the detected object.

The lidar may be disposed at an appropriate location outside the vehicle for sensing an object disposed at the front, back, or side of the vehicle.

The image capturer may be disposed at a suitable place outside the vehicle, for example, the front, back, right side mirrors and the left side mirror of the vehicle, in order to acquire a vehicle exterior image. The image capturer may be a mono camera, but is not limited thereto. The image capturer may be a stereo camera, an around view monitoring (AVM) camera, or a 360-degree camera.

The image capturer may be disposed close to the front windshield in the interior of the vehicle in order to acquire an image of the front of the vehicle. The image capturer may be disposed around the front bumper or the radiator grill.

The image capturer may be disposed close to the rear glass in the interior of the vehicle in order to acquire an image of the back of the vehicle. The image capturer may be disposed around the rear bumper, the trunk, or the tail gate.

The image capturer may be disposed close to at least one of the side windows in the interior of the vehicle in order to acquire an image of the side of the vehicle. In addition, the image capturer may be disposed around the fender or the door.

The image capturer may provide an image acquired to identify a passenger to the vehicle controller 2200.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object.

The ultrasonic sensor may be disposed at an appropriate position outside the vehicle for sensing an object at the front, back, or side of the vehicle.

The infrared sensor may include an infrared transmitting module, and an infrared receiving module. The infrared sensor may detect an object based on infrared light, and detect the location of the detected object, the distance from the detected object, and the relative speed of the detected object.

The infrared sensor may be disposed at an appropriate position outside the vehicle for sensing an object at the front, back, or side of the vehicle.

The vehicle controller 2200 may control the overall operation of the object detector 2400.

The vehicle controller 2200 may compare data sensed by the radar, the lidar, the ultrasonic sensor, and the infrared sensor with pre-stored data so as to detect or classify an object.

The vehicle controller 2200 may detect an object and perform tracking of the object based on the obtained image. The vehicle controller 2200 may perform operations such as calculation of the distance from an object and calculation of the relative speed of the object through image processing algorithms.

For example, the vehicle controller 2200 may obtain the distance information from the object and the relative speed information of the object from the obtained image based on the change of size of the object over time.

For example, the vehicle controller 2200 may obtain the distance information from the object and the relative speed information of the object through, for example, a pin hole model and road surface profiling.

The vehicle controller 2200 may detect an object and perform tracking of the object based on the reflected electromagnetic wave reflected back from the object. The vehicle controller 2200 may perform operations such as calculation of the distance to the object and calculation of the relative speed of the object based on the electromagnetic waves.

The vehicle controller 2200 may detect an object, and perform tracking of the object based on the reflected laser light reflected back from the object. Based on the laser light, the vehicle controller 2200 may perform operations such as calculation of the distance to the object and calculation of the relative speed of the object based on the laser light.

The vehicle controller 2200 may detect an object and perform tracking of the object based on the reflected ultrasonic wave reflected back from the object. The vehicle controller 2200 may perform operations such as calculation of the distance to the object and calculation of the relative speed of the object based on the reflected ultrasonic wave.

The vehicle controller 2200 may detect an object and perform tracking of the object based on the reflected infrared light reflected back from the object. The vehicle controller 2200 may perform operations such as calculation of the distance to the object and calculation of the relative speed of the object based on the infrared light.

Depending on the embodiment, the object detector 2400 may include a separate processor from the vehicle processor 2200. In addition, the radar, the lidar, the ultrasonic sensor, and the infrared sensor may each include a processor.

When a processor is included in the object detector 2400, the object detector 2400 may be operated under the control of the processor controlled by the vehicle controller 2200.

The driving controller 2500 may receive a user input for driving. In the case of the manual mode, the vehicle 2000 may operate based on the signal provided by the driving controller 2500.

The vehicle driver 2600 may electrically control the driving of various apparatuses in the vehicle 2000. The vehicle driver 2600 may electrically control the operations of a power train, a chassis, a door/window, a safety device, a lamp, and an air conditioner in the vehicle 2000.

The operator 2700 may control various operations of the vehicle 2000. The operator 2700 may operate in the autonomous driving mode.

The operator 2700 may include a driving module, an unparking module, and a parking module.

Depending on the embodiment, the operator 2700 may further include components other than the components to be described, or may not include some of the components.

The operator 2700 may include a processor under the control of the vehicle controller 2200. Each module of the operator 2700 may include a processor individually.

Depending on the embodiment, when the operator 2700 is implemented as software, it may be a sub-concept of the vehicle controller 2200.

The driving module may perform driving of the vehicle 2000.

The unparking module may perform unparking of the vehicle 2000.

The parking module may perform parking of the vehicle 2000.

The navigation module may provide the navigation information to the vehicle controller 2200. The navigation information may include at least one of map information, set destination information, route information according to destination setting, information about various objects on the route, lane information, or current location information of the vehicle.

The navigation module may include a memory. The memory may store navigation information. The navigation information may be updated by information received through the vehicle transceiver 2100. The navigation module may be controlled by an internal processor, or may operate by receiving an external signal, for example, a control signal from the vehicle controller 2200, but the present disclosure is not limited thereto.

The driving module of the operator 2700 may be provided with the navigation information from the navigation module, and may provide a control signal to the vehicle driving module so that driving of the vehicle 2000 may be performed.

The sensor 2800 may sense the state of the vehicle 2000 using a sensor mounted on the vehicle 2000, that is, a signal related to the state of the vehicle 2000, and obtain movement route information of the vehicle 2000 according to the sensed signal. The sensor 2800 may provide the obtained movement route information to the vehicle controller 2200.

The sensor 2800 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 2800 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 2800 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS).

The sensor 2800 may generate vehicle status information based on sensing data. The vehicle state information may be information generated based on data sensed by various sensors included in the inside of the vehicle.

Vehicle state information may include, for example, attitude information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, interior temperature information of the vehicle, interior humidity information of the vehicle, pedal position information, or vehicle engine temperature information.

The vehicle storage 2900 may be electrically connected to the vehicle controller 2200. The vehicle storage 2900 may store basic data on each unit of the vehicle information-linked content providing apparatus, control data for controlling the operation of each unit of the vehicle information-linked content providing apparatus, and input/output data. The vehicle storage 2900 may be various storage devices such as a ROM, a RAM, an EPROM, a flash drive, and a hard drive, in terms of hardware. The vehicle storage 2900 may store various data for overall operation of the vehicle 2000, such as a program for processing or controlling the vehicle controller 2200, in particular driver propensity information. The vehicle storage 2900 may be integrally formed with the vehicle controller 2200, or implemented as a sub-component of the vehicle controller 2200.

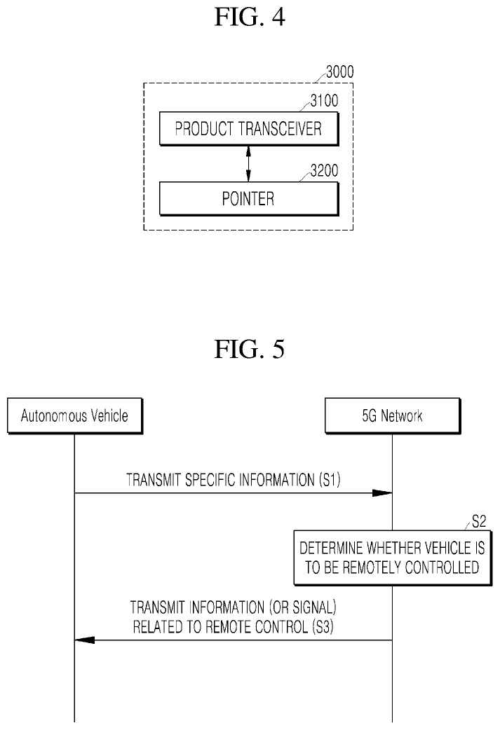

FIG. 4 is a block diagram illustrating a vehicle information-linked content providing apparatus according to an embodiment of the present disclosure which is installed in a product.

Referring to FIG. 4, the vehicle information-linked content providing apparatus may include a product transceiver 3100 and a pointer 3200.

According to an embodiment, the product 3000 to which the vehicle information-linked content providing apparatus is applied may include components other than components to be described which are illustrated in FIG. 4 or may not include some of the components to be described which are illustrated in FIG. 4.

The product transceiver 3100 may transmit an authentication code of the product 3000 by using the Bluetooth or NFC technique.

The pointer 3200 may irradiate a laser, specifically, an infrared laser to designate a coordinate aimed by the product 3000.

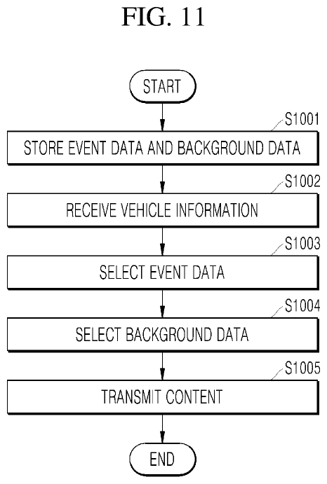

FIGS. 11 to 15 are operation flowcharts illustrating a vehicle information-linked content providing method according to an embodiment of the present disclosure.

The vehicle information-linked content providing method may include another step other than the steps to be described which are illustrated in FIGS. 11 to 15 or may not include some of steps to be described which are illustrated in FIGS. 11 to 15.

Referring to FIG. 11, the server storage 1300 may store a plurality of event data and a plurality of background data (S1001). In this case, the relationship of background data to event data may be one to multiple relationships as represented in Table 1.

The server transceiver 1100 may receive vehicle information including the character matching information from the vehicle 2000 (S1002).

The server controller 1200 may select event data including a character designated by the character matching information, from among the plurality of event data (S1003).

The server controller 1200 may select background data including an event designated by the event data, from among the plurality of background data (S1004).

The server controller 1200 may transmit, through the server transceiver 1100, content data including the selected event data and the selected background data (S1005).

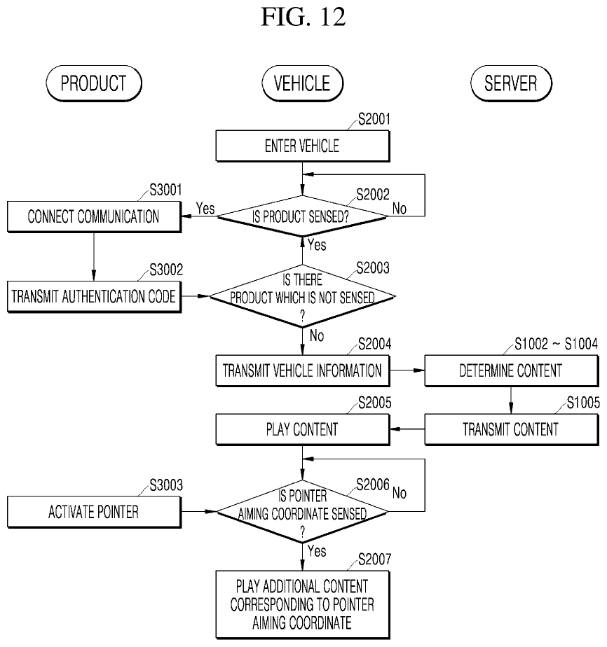

Referring to FIG. 12, when a user possessing the product 3000 enters the vehicle 2000 (S2001), the vehicle controller 2200 may sense the product 3000 through the vehicle transceiver 2100, for example, through the Bluetooth module of the vehicle transceiver 2100 or the internal camera of the user interface 2300 (S2002). The product sensing control operation of the vehicle controller 2200 may be repeated until the product 3000 is sensed.

The vehicle 2000 may be set to open the door of the vehicle only when an authentication code for providing the product 3000 or a predetermined boarding word, for example, a voice uttering a word such as “Heimdall” is confirmed. In this case, the vehicle controller 2200 may determine whether the product 3000 is a genuine product by using the authentication code and control the vehicle door to be open only when the product 3000 is a genuine product.

When the product 3000 is sensed using only the Bluetooth module of the vehicle transceiver 2100, the vehicle controller 2200 may also sense a product outside of the vehicle 2000 so that it is desirable to confirm whether the product 3000 is in the vehicle 2000 by using the internal camera of the user interface 2300.

When the product 3000 is not sensed, the vehicle controller 2200 may play default content data which may induce the purchase of the product 3000 through the user interface 2300.

Even though the product 3000 is sensed through the internal camera of the user interface 2300, when the authentication code is not received or a genuine product authentication code is not received through the vehicle transceiver 2100, the vehicle controller 2200 may play content data which induces the purchase of a genuine product through the user interface 2300.

When the product 3000 is sensed, the vehicle controller 2200 may connect the communication between the vehicle transceiver 2100 and the product transceiver 3100 and request the authentication to the product transceiver 3100 through the vehicle transceiver 2100 (S3001).

The product transceiver 3100 may transmit the authentication code and product information to the vehicle transceiver 2100 in response to an authentication request signal (S3002).

The vehicle controller 2200 may determine whether there is an additional product which is not sensed (S2003), and when there is an additional product, may perform an operation of sensing the product through the vehicle transceiver 2100 (S2002).

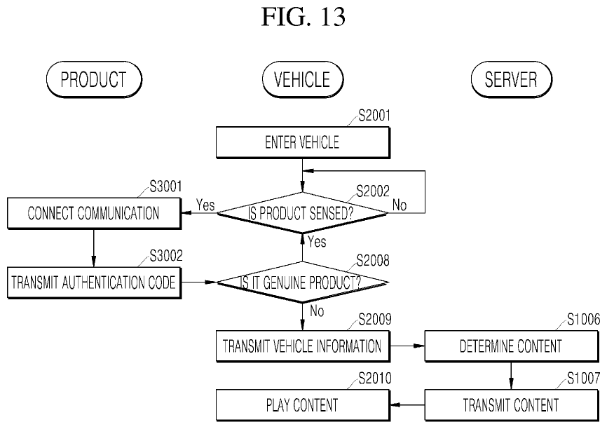

When there is no additional product, the vehicle controller 2200 may transmit vehicle information to the server transceiver 1100 through the vehicle transceiver 2100 (S2004). The vehicle controller 2200 may allow the authentication code and the product information to be included in the vehicle information as character matching information. As illustrated in FIG. 13, when a genuine product authentication process of the product 3000 is performed in the vehicle controller 2200, the vehicle controller 2200 may allow product information excluding the authentication code to be included in the vehicle information as the character matching information.

Further, the vehicle controller 2200 may transmit the vehicle information to the server 1000 and request the server 1000 to transmit content related to the product 3000.

When the vehicle information is received through the server transceiver 1100, the server controller 1200 may select event data including a character designated by the character matching information in the vehicle information, select background data including an event designated by the event data (S1002 to S1004), and transmit the content data including the selected event data and the selected background data to the vehicle transceiver 2100 through the server transceiver 1100 (S1005).

In this case, when a plurality of character matching information is included in the vehicle information, for example, when the user enters the vehicle with at least two products, the server controller 1200 may transmit the content data including event data and background data designated by the plurality of character matching information to the vehicle transceiver 2100 through the server transceiver 1100 (S1005). For example, when the authentication code or the product information included in the character matching information includes both Mjolnir and the shield of Captain America, the server controller 1200 may select an event in which both Thor and Captain America appear, for example, event data in which an event occurring in the movie Avengers is produced as data.

When the genuine product authentication process of the product 3000 is not performed in the vehicle controller 2200, the server controller 1200 may transmit, through the server transceiver 1100, the content data including the event data and the background data to the vehicle transceiver 2100 only when the product 3000 is admitted as a genuine product through the received authentication code.

The server controller 1200 may transmit a uniform resource locator (URL) address in which the content data is stored, instead of directly transmitting the content data file, to the vehicle transceiver 2100, through the server transceiver 1100 so as to download the content data by accessing the received URL address in the vehicle 2000.

The vehicle controller 2200 may play the content data provided from the server 1000 through the user interface 2300 (S2005).

The user possessing the product 3000 may activate the pointer 3200, for example, an infrared laser pointer, to experience the content which reacts to a motion of the user in real time during the playing of the content data (S3003).

The vehicle controller 2200 may sense a coordinate position, which is aimed by the pointer 3200 in the display module playing content data, through the infrared laser sensing module of the user interface 2300 (S2006).

When the coordinate position, which is aimed by the pointer 3200 in the display module playing content data, is sensed, the vehicle controller 2200 may play image data added so as to correspond to the pointer aiming coordinate (S2007). For example, when the user aims a predetermined point of an image being played by an infrared laser pointer mounted in Thor's hammer, Mjolnir, the vehicle controller 2200 may play an image showing that a character in the image disposed in the coordinate aimed by the pointer is hit by a thunderbolt.

Referring to FIG. 13, when a user possessing the product 3000 enters the vehicle 2000 (S2001), the vehicle controller 2200 may sense the product 3000 through the vehicle transceiver 2100, for example, through the Bluetooth module of the vehicle transceiver 2100 or the internal camera of the user interface 2300 (S2002). The product sensing control operation of the vehicle controller 2200 may be repeated until the product 3000 is sensed.

When the product 3000 is sensed, the vehicle controller 2200 may connect the communication between the vehicle transceiver 2100 and the product transceiver 3100, and request the product transceiver 3100 for authentication through the vehicle transceiver 2100 (S3001).

The product transceiver 3100 may transmit the authentication code and product information to the vehicle transceiver 2100 in response to the authentication request signal (S3002).

The vehicle controller 2200 may determine whether the product 3000 is a genuine product by using the authentication code (S2008), and when the product 3000 is a genuine product, may transmit the vehicle information to the server transceiver 1100 through the vehicle transceiver 2100 (S2009). The vehicle controller 2200 may allow the product information, excluding the authentication code, to be included in the vehicle information as character matching information.

Further, the vehicle controller 2200 may transmit the vehicle information to the server 1000 and request the server 1000 to transmit the content related to the product 3000.

When the vehicle information is received through the server transceiver 1100, the server controller 1200 may select event data including a character designated by the character matching information in the vehicle information, select background data including an event designated by the event data (S1006), and transmit the content data including the selected event data and the selected background data to the vehicle transceiver 2100 through the server transceiver 1100 (S1007).

In this case, when a plurality of character matching information is included in the vehicle information, for example, when at least two users enter the vehicle with at least one product, respectively, the server controller 1200 may transmit the content data including event data and background data designated by the plurality of character matching information to the vehicle transceiver 2100 through the server transceiver 1100. For example, when the authentication code or the product information included in the character matching information includes both Mjolnir and the shield of Captain America, the server controller 1200 may select an event in which both Thor and Captain America appear, for example, event data in which an event occurring in the movie Avengers is produced as data.

The server controller 1200 may transmit a uniform resource locator (URL) address in which the content data is stored, instead of directly transmitting the content data file, to the vehicle transceiver 2100 through the server transceiver 1100 so as to download the content data by accessing the received URL address in the vehicle 2000.

The vehicle controller 2200 may play the content data provided from the server 1000 through the user interface 2300 (S2010).

The user possessing the product 3000 may activate the pointer 3200, for example, an infrared laser pointer, to experience the content which reacts to a motion of the user in real time during the playing of the content data.

The vehicle controller 2200 may sense a coordinate position, which is aimed by the pointer 3200 in the display module playing content data, through the infrared laser sensing module of the user interface 2300.

When the coordinate position, which is aimed by the pointer 3200 in the display module playing content data, is sensed, the vehicle controller 2200 may play image data added so as to correspond to the pointer aiming coordinate.

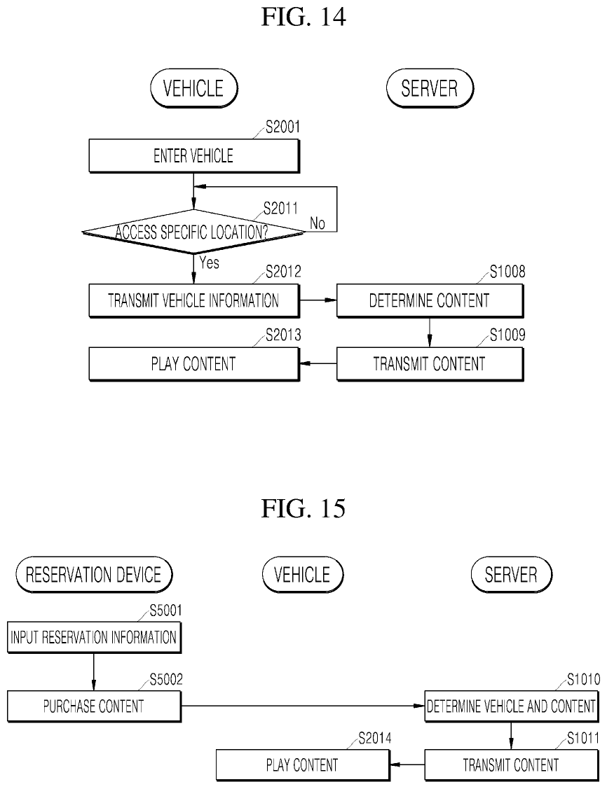

Referring to FIG. 14, when a user possessing the product 3000 enters the vehicle 2000 (S2001), the vehicle controller 2200 may receive position information of the vehicle 2000 through a GPS module of the vehicle transceiver 2100 and determine whether to access a specific location 4000 (S2011).

The vehicle controller 2200 may transmit and receive a signal through a communication module installed in the specific location 4000 and the vehicle transceiver 2100 to determine whether to access the specific location 4000.

The vehicle controller 2200 may transmit vehicle information to the server transceiver 1100 through the vehicle transceiver 2100 (S2012). The vehicle controller 2200 may allow the position information to be included in the vehicle information as character matching information.

Further, the vehicle controller 2200 may transmit the vehicle information to the server 1000 and request the server 1000 to transmit content related to the specific location 4000, for example, the attraction.

When the vehicle information is received through the server transceiver 1100, the server controller 1200 may select event data including a character designated by the position information in the vehicle information, select background data including an event designated by the event data (S1008), and transmit the content data including the selected event data and the selected background data to the vehicle transceiver 2100 through the server transceiver 1100 (S1009).

The server controller 1200 may transmit a uniform resource locator (URL) address in which the content data is stored, instead of directly transmitting the content data file, to the vehicle transceiver 2100 through the server transceiver 1100 so as to download the content data by accessing the received URL address in the vehicle 2000.

The vehicle controller 2200 may play the content data provided from the server 1000 through the user interface 2300 (S2013).

Referring to FIG. 15, the user may input reservation information, for example, a request for allocating the vehicle 2000 and a request for playing predetermined content data in the vehicle 2000, through the reservation device 5000 (S5001).

The user may purchase the content to play predetermined content data in the vehicle 2000 (S5002), and when the content purchase is completed, the reservation information may be transmitted to the server 1000 through the communication module installed in the reservation device 5000. The server controller 1200 may receive reservation information through the server transceiver 1100 and determine allocation of the vehicle 2000 and content data to be played in accordance with the received reservation information, that is, content data including event data and background data (S1010).

The server controller 1200 may transmit content data including the selected event data and the selected background data to the vehicle transceiver 2100 through the server transceiver 1100 (S1011).

The server controller 1200 may transmit a uniform resource locator (URL) address in which the content data is stored, instead of directly transmitting the content data file, to the vehicle transceiver 2100 through the server transceiver 1100 so as to download the content data by accessing the received URL address in the vehicle 2000.

The vehicle controller 2200 may play the content data which is provided from the server 1000 through the user interface 2300 (S2014).

The present disclosure described above can be embodied as computer-readable codes on a medium on which a program is recorded. The computer readable medium includes all types of recording devices in which data readable by a computer system readable can be stored. Examples of computer readable media may include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and the computer readable medium may also be implemented in the form of a carrier wave (for example, transmission over the Internet). In addition, the computer may include a processor or a controller. Accordingly, the above-detailed description should not be construed as limiting in all aspects and should be considered as illustrative. The scope of the present disclosure should be determined by rational interpretation of the appended claims, and all changes within the scope of equivalents of the present disclosure are included in the scope of the present disclosure.

What is claimed is:

1. A vehicle information-linked content providing apparatus which provides content linked with information provided by a vehicle, the apparatus comprising:
a storage configured to store a plurality of event data and a plurality of background data;
a transceiver configured to receive vehicle information including character matching information; and
a controller configured to:
select event data including a character designated by the character matching information, from among the plurality of event data;
select background data including an event designated by the event data, from among the plurality of background data; and
transmit, through the transceiver, content data including the selected event data and the selected background data.

2. The vehicle information-linked content providing apparatus according to claim 1, wherein:
the vehicle information includes an authentication code, and
the controller is configured to:
determine that a product assigned with the authentication code is a genuine product based on comparing the authentication code with genuine product determining information, and
transmit the content data through the transceiver based on the determination that the product is a genuine product.

3. The vehicle information-linked content providing apparatus according to claim 2, wherein the event data includes image data added so as to correspond to a pointer aiming coordinate of the product.

4. The vehicle information-linked content providing apparatus according to claim 1, wherein:
the character matching information includes vehicle position information, and
the controller is configured to designate a character in accordance with a characteristic of a location adjacent to a vehicle location based on the vehicle position information.

5. The vehicle information-linked content providing apparatus according to claim 1, wherein:
the character matching information includes inside-vehicle image information, and the controller is configured to designate a character based on the inside-vehicle image information.

6. The vehicle information-linked content providing apparatus according to claim 1, wherein:
the character matching information includes inside-vehicle voice information, and
the controller is configured to designate a character based on the inside-vehicle voice information.

7. The vehicle information-linked content providing apparatus according to claim 1, wherein:
the storage stores a history of providing the content data, and
the controller is configured to:
select at least one new event data which has not been provided, from among the plurality of event data, based on the providing history, and
select event data including a character designated by the character matching information, from among the at least one new event data.

8. The vehicle information-linked content providing apparatus according to claim 1, wherein the transceiver is configured to receive the vehicle information based on an uplink grant of a 5G network connected to drive the vehicle in an autonomous driving mode.

9. A vehicle information-linked content providing method which provides content linked with information provided by a vehicle, the method comprising:
storing a plurality of event data and a plurality of background data;
receiving vehicle information including character matching information;
selecting event data including a character designated by the character matching information, from among the plurality of event data;
selecting background data including an event designated by the event data, from among the plurality of background data; and
transmitting content data including the selected event data and the selected background data.

10. The vehicle information-linked content providing method according to claim 9, wherein:
the vehicle information includes an authentication code, and
the transmitting of content data includes:
determining that a product assigned with the authentication code is a genuine product based on comparing the authentication code with genuine product determining information; and
transmitting content data including the event data and the background data based on the determination that the product is a genuine product.

11. The vehicle information-linked content providing method according to claim 10, wherein the event data includes image data added so as to correspond to a pointer aiming coordinate of the product.

12. The vehicle information-linked content providing method according to claim 9, wherein:
the character matching information includes vehicle position information, and
the selecting of event data includes:
designating a character in accordance with a characteristic of a location adjacent to a vehicle location based on the vehicle position information.

13. The vehicle information-linked content providing method according to claim 9, wherein:
the character matching information includes inside-vehicle image information, and
the selecting of event data includes:
designating a character based on the inside-vehicle image information.

14. The vehicle information-linked content providing method according to claim 9, wherein:
the character matching information includes inside-vehicle voice information, and
the selecting of event data includes:
designating a character based on the inside-vehicle voice information in the vehicle.

15. The vehicle information-linked content providing method according to claim 9, further comprising:
storing a history of providing the content data,
wherein the selecting of event data includes:
selecting at least one new event data which has not been provided, from among the plurality of event data, based on the providing history; and
selecting event data including a character designated by the character matching information, from among the at least one new event data.

16. The vehicle information-linked content providing method according to claim 9, wherein the receiving of vehicle information includes:
receiving the vehicle information based on an uplink grant of a 5G network connected to drive the vehicle in an autonomous driving mode.

17. A computer readable recording medium in which a vehicle information-linked content providing program which provides content linked with information provided by a vehicle is recorded, the vehicle information-linked content providing program causing a computer to perform:
storing of a plurality of event data and a plurality of background data;
receiving of vehicle information including character matching information;
selecting of event data including a character designated by the character matching information, from among the plurality of event data;
selecting of background data including an event designated by the event data, from among the plurality of background data; and
transmitting of content data including the selected event data and the selected background data.
